(19) United States
(12) Patent Application Publication
(10) Pub. No.: US 2014/0060196 A1
(43) Pub. Date: Mar. 6, 2014

(54) ULTRASONIC TESTING APPARATUS

(71) Applicants: Stephan FALTER, Simmerath (DE); Dieter LINGENBERG, Huerth (DE)

(72) Inventors: Stephan FALTER, Simmerath (DE); Dieter LINGENBERG, Huerth (DE)

(73) Assignee: General Electric Company, Schenctady, NY (US)

(21) Appl. No.: 13/601,004

(22) Filed: Aug. 31, 2012

(51) Int. Cl. G01N 29/00

(52) U.S. Cl. 73/632

(57) ABSTRACT

A plurality of subsets of ultrasonic transducers in an array of ultrasonic transducers are configured to transmit ultrasonic waves at various angles simultaneously toward a test object so that an anomaly of any orientation in the test object can be detected efficiently.

### BACKGROUND OF THE INVENTION

The subject matter disclosed herein relates to an ultrasonic testing apparatus and, in particular, to a testing apparatus comprising an array of ultrasonic transducers.

Nondestructive testing devices can be used to inspect test objects to detect and analyze anomalies in the objects. Nondestructive testing allows an inspection technician to maneuver a probe or sensor near the surface of the test object in order to perform testing of both the object surface and its underlying structure. One example of nondestructive testing is ultrasonic testing.

In an ultrasonic testing system, electrical pulses are transmitted to an ultrasonic probe where they are transformed into ultrasonic pulses by one or more ultrasonic transducers (e.g., piezoelectric elements) in the ultrasonic probe. During operation, the electrical pulses are applied to the electrodes of one or more ultrasonic transducers, generating ultrasonic waves that are transmitted into the test object to which the probe is coupled. As the ultrasonic waves pass through the test object, various reflections, called echoes, occur as the ultrasonic wave interacts with anomalies in the test object. Conversely, when an ultrasonic wave is reflected back from the test object and is received by the piezoelectric surface of the ultrasonic transducers, it causes the transducers to vibrate generating a voltage difference across the electrodes that is detected as an electrical signal received by signal processing electronics. By tracking the time difference between the transmission of the electrical pulse and the receipt of the electrical signal, and measuring the amplitude of the received electrical signal, various characteristics of the anomaly (e.g., depth, size, orientation) can be determined.

A phased array ultrasonic probe has a plurality of electrically and acoustically independent ultrasonic transducers in a single array. By varying the timing of the electrical pulses applied to the ultrasonic transducers using delay laws, a phased array ultrasonic probe can generate ultrasonic waves at different angles (e.g., from zero to one hundred eighty degrees at two degree increments) through the test object to try to detect anomalies and identify the orientation of those anomalies. For example, to generate an ultrasonic wave at thirty degrees, the transmit delays for the ultrasonic transducers of the phased array ultrasonic probe can be set in a first configuration of values. To then generate an ultrasonic wave at thirty-two degrees, the transmit delays for the ultrasonic transducers of the phased array ultrasonic probe can be set in a second configuration of values. This sequential generation and then receipt of the ultrasonic waves at each of the different angles is quite time consuming and results in a long time of inspection of the test object, especially if a one hundred eighty degree scan is required at different locations on the test object.

The discussion above is merely provided for general background information and is not intended to be used as an aid in determining the scope of the claimed subject matter.

### BRIEF DESCRIPTION OF THE INVENTION

A plurality of subsets of ultrasonic transducers in an array of ultrasonic transducers are configured to transmit ultrasonic waves at various angles substantially simultaneously toward a test object so that an anomaly of any orientation in the test object can be detected efficiently. An advantage that may be realized in the practice of some disclosed embodiments of the ultrasonic testing apparatus is that simultaneous multidirectional transmission of ultrasonic energy reduces inspection time.

In one embodiment an array of ultrasonic transducers comprises first and second subsets of ultrasonic transducers wherein the first subset is different from the second. A transmitter control module is connected to the first and second subsets of ultrasonic transducers and includes a control module with a first set of delays for controlling timing of ultrasonic pulses emitted by the first subset of ultrasonic transducers. The control module also includes a second set of delays for controlling the timing of ultrasonic pulses emitted by the second subset of ultrasonic transducers. The first subset of ultrasonic transducers emits an ultrasonic wave at a first angle substantially simultaneously with the second subset of ultrasonic transducers emitting a wave at a second angle.

In one embodiment, an ultrasonic probe comprises first and second subsets of ultrasonic transducers wherein the first subset of ultrasonic transducers is different from the second. Control lines connected to each ultrasonic transducer in the first and second subsets control the timing of ultrasonic pulses emitted by the first subset of ultrasonic transducers according to a first set of delays and control the timing of ultrasonic pulses emitted by the second subset of ultrasonic transducers according to a second set of delays. The first subset of ultrasonic transducers transmits a wave at a first angle simultaneously with the second subset of ultrasonic transducers emitting another wave at a second angle.

In one embodiment, a method of operating an ultrasonic testing apparatus comprises transmitting a first set of electrical pulses to a first subset of ultrasonic transducers in an array based on a first set of transmit delays, and transmitting a second set of electrical pulses to a second subset of ultrasonic transducers in the array based on a second set of transmit delays. The first and second subsets of ultrasonic transducers are different. Then the first subset of ultrasonic transducers transmit a first ultrasonic wave at a first angle toward a test object, wherein the angle is determined by the first set of transmit delays. Simultaneously, the second subset of ultrasonic transducers transmit a second ultrasonic wave toward the test object at a second angle, wherein the second angle is determined by the second set of transmit delays.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic diagram of an exemplary two dimensional array of ultrasonic transducers scanning a test object;

FIG. 2 is a diagram of an exemplary signal processing system for controlling an ultrasonic transducer array; and

FIG. 3 is a flow diagram of a method of operating an ultrasonic inspection apparatus.

### DETAILED DESCRIPTION OF THE INVENTION

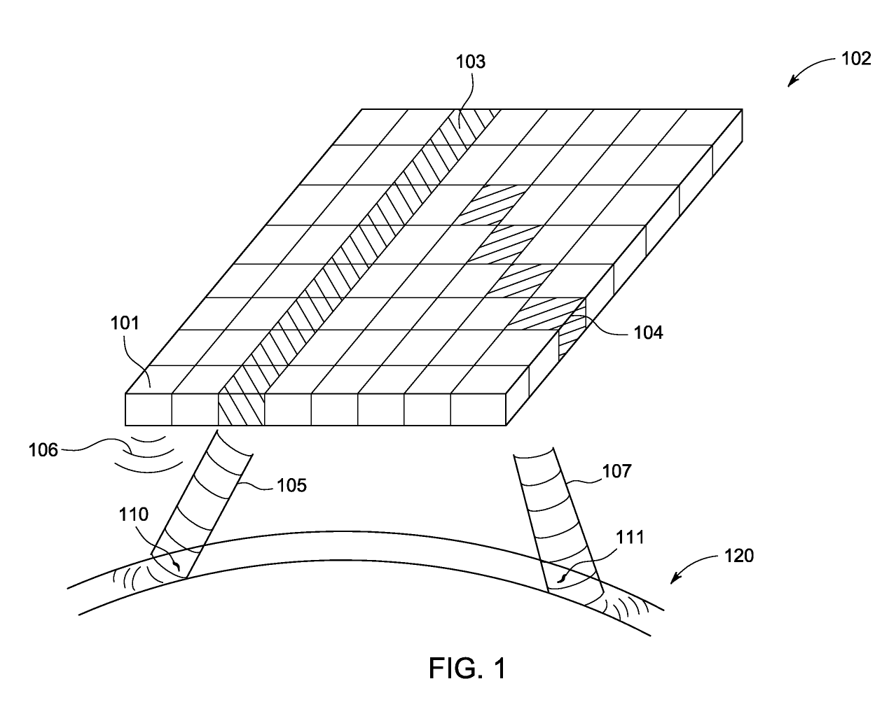

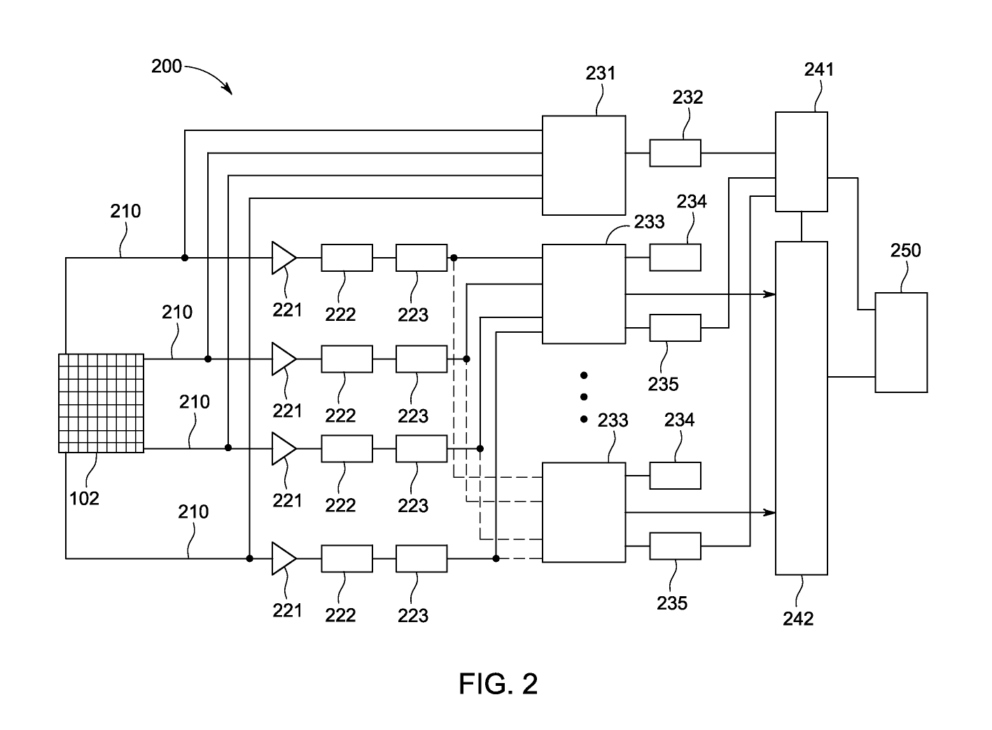

FIG. 1 is a schematic diagram of an exemplary two dimensional ultrasonic transducer array 102 whose transmitted ultrasonic waves 105, 107 are directed at a test object 120. FIG. 2 is a diagram of an exemplary signal processing system 200 for controlling the ultrasonic transducer array 102 of FIG. 1. Typically, the ultrasonic transducer array 102 is disposed within a probe (not shown) as part of an ultrasonic testing system, but is shown in FIG. 1 in schematic form. The arrangement of transducers 101 in the ultrasonic transducer array 102 as illustrated in FIG. 1, an 8×8 array, is not intended to limit possible configurations as the number and arrangement of transducers 101 can assume various quantities and layouts.

Each transducer 101 is capable of transmitting ultrasonic pulses 106 toward a test object 120 (e.g., through a water column) in a direction that is fixed according to the orientation of the transducer 101. A plurality of ultrasonic pulses 106 from a plurality of transducers 101 produce an ultrasonic wave at a predetermined angle. Each transducer 101 also receives ultrasonic waves reflected from test object 120. The transmission and receipt of the ultrasonic waves is controlled by signal processing system 200 described below. By controlling the timing of the ultrasonic pulses 106 from selected subsets of transducers 101 in the ultrasonic transducer array 102, the transmitted pulses 106 can be coordinated into directed ultrasonic waves 105, 107.

An exemplary first subset 103 of transducers 101 are controlled by the signal processing system 200 to transmit ultrasonic pulses, or pulse trains, in a coordinated time delay relationship to transmit a first ultrasonic wave 105 directed toward test object 120 at a first angle determined by a first set of transmit delays. Similarly, a second subset 104 of transducers 101, different than the first subset 103 of ultrasonic transducers 101, are controlled by the signal processing system 200 of FIG. 2 to transmit ultrasonic pulses in a coordinated time delay relationship to transmit a second ultrasonic wave 107 directed toward test object 120 at a second angle, different than the first angle, determined by a second set of transmit delays. Exemplary ultrasonic waves 105 and 107 are transmitted substantially simultaneously for efficient scanning of test object 120. Other subsets of transducers 101 in the ultrasonic transducer array 102, comprising any number and combination of transducers 101, can be similarly selected and coordinated to transmit ultrasonic waves at various ranges of predetermined angles simultaneously (e.g., 0 to 360 degrees). The ranges predetermined angles can comprise a setup for different ultrasonic waves targeting different paths in a test object. The controlled coordination of the set of transmit delays for each subset of transducers 101 determines the angle at which the ultrasonic wave is transmitted and, therefore, the angle at which the ultrasonic wave impacts the test object 120. This process of temporal pulse shaping also controls characteristics of the ultrasonic wave front, for example, its frequency. Thus, multiple subsets of transducers 101 in the ultrasonic transducer array 102 can be programmably selected, and each subset independently coordinated with different sets of transmit delays for targeting a test object 120 with multiple ultrasonic waves. By simultaneously directing these ultrasonic waves at a predetermined test area of the test object, testing efficiency can be increased. It will also be understood that two or more subsequent delay sets can be utilized to detect anomalies at different depths within a piece of material using different delay values.

Referring again to FIG. 1, there is illustrated an exemplary test area, i.e. a “slice”, through the material of the test object 120 bounded by the ultrasonic waves 105 107. Anomalies 110 and 111 are in the slices bounded by ultrasonic waves 105, 107, respectively, and generate reflected ultrasonic waves that are received by the ultrasonic transducer array 102 and analyzed by the signal processing system 200 of FIG. 2. The location and orientation of an anomaly 110, 111 in the test object 120 can be detected using one or more of the ultrasonic waves simultaneously transmitted at different angles. By correlating transmitted ultrasonic waves with received reflected ultrasonic waves, a location and orientation of an anomaly can be determined. Thus, the capability of transmitting ultrasonic waves at multiple angles simultaneously from an ultrasonic transducer array 102 produces an efficient ultrasonic testing system configuration and methodology.

Generally, an anomaly is indicated when the amplitude of a reflected ultrasonic wave deviates from an expected magnitude. A threshold deviation amount can be predetermined and programmed into the signal processing system 200 of FIG. 2, as explained below, to issue a notification signal when an anomaly is detected. The notification signal can comprise an audible signal, or a stored flag for handling at a later time. Gains in testing efficiency are realized by simultaneously transmitting timed ultrasonic pulses in predetermined patterns so that a number of ultrasonic waves impact the test object at various angles. For example, alternative transmission patterns can include a cyclic or helical model. The predesigned transmission patterns of ultrasonic pulses comprise a series of transmit/receive scanning cycles which rapidly test component areas for the presence of anomalies having various orientations in the test object 120.

With reference to FIG. 2, there is illustrated signal processing system 200 connected to the ultrasonic transducer array 102 of FIG. 1 over control lines 210. While only four representative control lines 210 are shown in FIG. 2, each transducer 101 in the ultrasonic transducer array 102 is connected to the processing system by a control line, with each control line 210 used for transmitting electrical signals to, and receiving electrical signals from, the ultrasonic transducer array 102. It will be understood that the modules of the signal processing system can comprises a variety of different devices, including field programmable gate arrays (FPGAs), application specific integrated circuits (ASICs), read only memory (ROM), random access memory (RAM), etc.

The signal processing system 200 includes a transmitter control module 231. Transmitter control module 231 sends electrical pulses to the transducers 101 in the ultrasonic transducer array 102 over control lines 210, which convert the electrical pulses into ultrasonic pulses. Transmitter settings module 232 provides the transmit delays for each of the transducers 101 to the transmitter control module 231 to coordinate a timing relationship for each subset of the transducers 101 to transmit an ultrasonic wave at a predetermined impact angle. The signal processing system 200 also includes cycle control module 241 connected to the transmitter settings module 232 to coordinate and correlate the transmission of the transmitted ultrasonic waves at different impact angles. In addition to being connected to the transmitter control module 231, each transducer 101 of the ultrasonic transducer array 102 is connected to an amplifier 221, filter 222, and A/D converter 223 for receiving and digitizing reflected ultrasonic waves from the test object. The reflected ultrasonic waves are produced from the ultrasonic waves transmitted by the same ultrasonic transducer array 102.

The signal processing system 200 also comprises a number of summer modules 233 connected to the A/D converters 223 for receiving digitized data representing the reflected ultrasonic waves from the test object. The summer modules 233 can be connected to A/D converters 223 to receive digitized outputs of the ultrasonic transducer array 102, in various combinations depending on the processing requirements for any particular testing scheme employed by the ultrasonic testing system. Outputs from each of the summer modules 233 can be received for immediate processing at connected evaluation units 242, or they can be recorded in receiver storage modules 234, connected to each summer module 233, for processing at a later time. The summer modules 233 can receive inputs from the receiver settings module 235 that include delay data derived in combination with the coordinated transmit delays in the transmitter settings module 232, described above, under control of cycle control module 241 for managing appropriate delay correlations between timed pulses for generating ultrasonic pulses and received reflected ultrasonic waves.

Evaluation units 242, connected to receive outputs from the summer modules 233 and connected to cycle control module 241 analyze the ultrasonic digitized data and generate A-scan information as an output to the processing electronics 250. Threshold deviation magnitudes for triggering anomaly determinations can be programmed into the evaluation units 242 so that the anomaly indications are included in the A-scan output. The evaluation units 242 can be configured to receive data from each of the summer modules 233 for immediate processing, or they can receive previously stored data from receiver storage modules 234. The processing electronics 250 can include a personal computer or digital signal processor (DSP) for managing the inputs/outputs of the signal processing system 200, which includes control and reception data to and from the ultrasonic transducer array 102, storage, a user interface for technicians, including selecting controls for how to handle or issue notifications for detected anomalies, and for managing the display of processed scanning data for the test object.

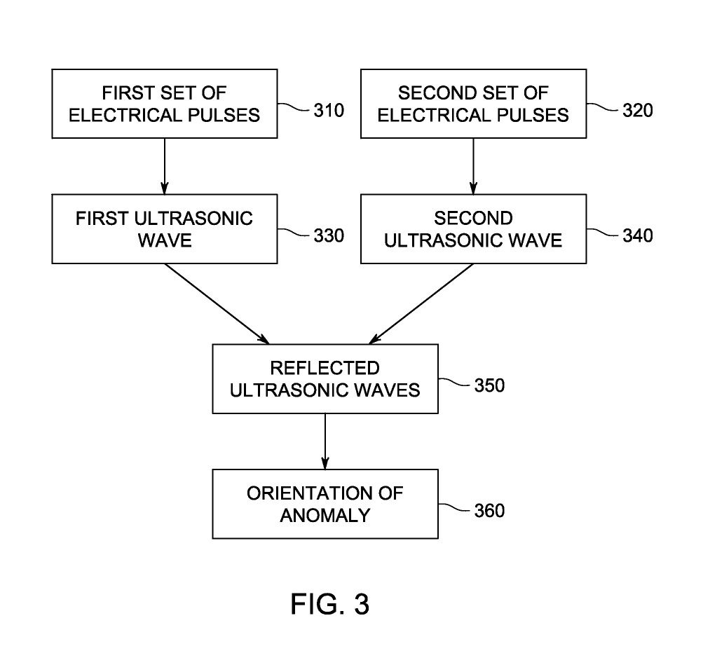

FIG. 3 is a flow diagram of a method of operating an ultrasonic inspection apparatus. At step 310, the signal processing system 200 transmits a first set of electrical pulses to a first subset 103 of ultrasonic transducers 101 in an ultrasonic transducer array 102 based on a first set of transmit delays. At step 320, the signal processing system 200 transmits a second set of electrical pulses to a second subset 104 of ultrasonic transducers 101 in the ultrasonic transducer array 102 based on a second set of transmit delays, wherein the second subset of ultrasonic transducers 101 are different than the first subset of ultrasonic transducers 101. The first and second sets of transmit delays can be accessed from the transmitter settings module 232. The signal processing system 200 can transmit additional sets of electrical pulses to more different subsets 104 of ultrasonic transducers 101 in the ultrasonic transducer array 102 based on additional stored sets of transmit delays. Thus, the present description of first and second sets of transmit delays should not be interpreted in a limiting sense.

At step 330, the first subset 103 of ultrasonic transducers 101 transmits a first ultrasonic wave 105 at a first angle toward a test object 120 based on the first set of transmit delays. At step 340, the second subset 104 of ultrasonic transducers 101 transmits a second ultrasonic wave 107 toward the test object 120 at a second angle based on the second set of transmit delays, wherein the first ultrasonic wave 105 and the second ultrasonic wave 107 are transmitted substantially simultaneously. At step 350, the signal processing system 200 receives a plurality of reflected ultrasonic waves from the test object 120, wherein the reflected ultrasonic waves originate from the first ultrasonic wave 105 and the second ultrasonic wave 107. At step 360, the signal processing system 200 determines the orientation and location of an anomaly 110, 111 in the test object 120 based on the plurality of reflected ultrasonic waves.

In view of the foregoing, embodiments of the invention increase component testing efficiency by simultaneously transmitting ultrasonic waves at varying angles toward a test object in order to detect anomalies having orientations at any angle. A technical effect is a transmission of ultrasonic energy having complex ultrasonic waves and resultant processing of received reflected ultrasonic waves.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An ultrasonic testing apparatus comprising:
an array of ultrasonic transducers comprising a first subset of ultrasonic transducers and a second subset of ultrasonic transducers, wherein the first subset of ultrasonic transducers is different from the second subset of ultrasonic transducers; and
a transmitter control module connected to each of the first subset of ultrasonic transducers and each of the second subset of ultrasonic transducers, the transmitter control module comprising a first set of delays for controlling the timing of the transmission of ultrasonic pulses by the first subset of ultrasonic transducers and a second set of delays for controlling the timing of the transmission of ultrasonic pulses by the second subset of ultrasonic transducers;
wherein a first ultrasonic wave transmitted by the first subset of ultrasonic transducers comprises a first angle and the second ultrasonic wave transmitted by the second subset of ultrasonic transducers comprises a second angle, and wherein the first ultrasonic wave and the second ultrasonic wave are transmitted substantially simultaneously.

2. The ultrasonic testing apparatus of claim 1, wherein the array of ultrasonic transducers further comprises additional subsets of ultrasonic transducers and wherein the transmitter control module comprises additional sets of delays, whereby each of the additional subsets of ultrasonic transducers transmit an ultrasonic wave at a different angle such that the ultrasonic waves transmitted by all the subsets of ultrasonic transducers comprise a predetermined range of angles.

3. The ultrasonic testing apparatus of claim 2, wherein the predetermined range of angles comprises a range of about 0 to 360 degrees.

4. The ultrasonic testing apparatus of claim 2, wherein the predetermined range of angles defines a predetermined test area of a test object.

5. The ultrasonic testing apparatus of claim 2, wherein the predetermined range of angles comprises a setup for different ultrasonic waves targeting different paths in a test object.

6. The ultrasonic testing apparatus of claim 1, wherein the first angle and the second angle are determined by the first set of delays and the second set of delays, respectively.

7. The ultrasonic testing apparatus of claim 1 further comprising a transmitter settings module connected to the transmitter control module, wherein the transmitter settings module provides the first set of delays and the second set of delays.

8. The ultrasonic testing apparatus of claim 1 further comprising an amplifier, filter, and analog-to-digital converter connected to each of the of ultrasonic transducers in the first subset of ultrasonic transducers and the second subset of ultrasonic transducers.

9. The ultrasonic testing apparatus of claim 4 further comprising a receiver storage module for storing data representing ultrasonic waves reflected from the test object.

10. An ultrasonic probe comprising:
an array of ultrasonic transducers comprising a first subset of ultrasonic transducers and a second subset of ultrasonic transducers, wherein the first subset of ultrasonic transducers is different from the second subset of ultrasonic transducers; and
control lines connected to each of the first subset of ultrasonic transducers and each of the second subset of ultrasonic transducers, the control lines receiving a first set of delays for controlling the timing of the transmission of ultrasonic pulses by the first subset of ultrasonic transducers and a second set of delays for controlling the timing of the transmission of ultrasonic pulses by the second subset of ultrasonic transducers;
wherein a first ultrasonic wave transmitted by the first subset of ultrasonic transducers comprises a first angle and the second ultrasonic wave transmitted by the second subset of ultrasonic transducers comprises a second angle, and wherein the first ultrasonic wave and the second ultrasonic wave are transmitted substantially simultaneously.

11. The ultrasonic probe of claim 10, wherein the array of ultrasonic transducers further comprises additional subsets of ultrasonic transducers and wherein the control lines receive additional sets of delays, whereby each of the additional subsets of ultrasonic transducers transmit an ultrasonic wave at a different angle such that the ultrasonic waves transmitted by all the subsets of ultrasonic transducers comprise a predetermined range of angles.

12. The ultrasonic probe of claim 11, wherein the predetermined range of angles comprises a range of about 0 to 360 degrees.

13. The ultrasonic probe of claim 11, wherein the predetermined range of angles defines a predetermined test area of a test object.

14. The ultrasonic probe of claim 10, wherein the first angle and the second angle are determined by the first set of delays and the second set of delays, respectively.

15. A method of operating an ultrasonic testing apparatus, comprising the steps of:
transmitting a first set of electrical pulses to a first subset of ultrasonic transducers in an array based on a first set of transmit delays;
transmitting a second set of electrical pulses to a second subset of ultrasonic transducers in the array based on a second set of transmit delays, wherein the second subset of ultrasonic transducers are different than the first subset of ultrasonic transducers;
transmitting from the first subset of ultrasonic transducers a first ultrasonic wave at a first angle toward a test object based on the first set of transmit delays; and
transmitting from the second subset of ultrasonic transducers a second ultrasonic wave toward the test object at a second angle based on the second set of transmit delays,
wherein the first ultrasonic wave and the second ultrasonic wave are transmitted substantially simultaneously.

16. The method of claim 15, further comprising the steps of:
receiving a plurality of reflected ultrasonic waves from the test object, wherein the reflected ultrasonic waves are from the first ultrasonic wave and the second ultrasonic wave; and
determining the orientation of an anomaly in the test object based on the plurality of reflected ultrasonic waves.

17. The method of claim 15, further comprising the steps of accessing the first set of delays and the second set of delays from a transmitter settings module.
